(19) United States
(12) Patent Application Publication
(10) Pub. No.: US 2013/0100447 A1
(43) Pub. Date: Apr. 25, 2013

(54) OPTICAL SENSING UTILIZING OPTICAL CRYSTAL AND POLARIZATION MEASUREMENTS

(71) Applicant: Joseph C. Joseph, Houston, TX (US)

(72) Inventor: Joseph C. Joseph, Houston, TX (US)

(73) Assignee: BAKER HUGHES INCORPORATED, Houston, TX (US)

(21) Appl. No.: 13/276,913

(22) Filed: Oct. 19, 2011

(51) Int. Cl. G01V 8/14; G01J 4/00

(52) U.S. Cl. 356/369

(57) ABSTRACT

An apparatus for measuring a parameter includes: an optical crystal having an optical axis and configured to be disposed at a selected location; an optical signal source in optical communication with a surface of the crystal and configured to transmit an optical signal having an initial polarization to the surface, the surface configured to reflect at least a portion of the signal as a reflected signal; a detector configured to receive the reflected signal; and a processor configured to determine a polarization of the reflected signal and estimate the parameter at the location based on the polarization of the reflected signal.

### BACKGROUND

Boreholes are drilled deep into the earth for many applications such as hydrocarbon exploration and production. Many different types of tools and instruments may be disposed in the boreholes to perform various tasks, such as formation evaluation and drilling monitoring. During drilling, evaluation and other operations, it is often useful to measure various environmental parameters. For example, downhole pressure is monitored during production operations, so that operational parameters can be adjusted or steps otherwise taken to avoid unacceptably high pressures, which can lead to complications such as blowouts. In addition, downhole temperatures are often monitored. Sensors used to measure such parameters must be designed to be able to take accurate measurements in extreme environments experienced downhole, including elevated temperatures and pressures.

### SUMMARY

An apparatus for measuring a parameter includes: an optical crystal having an optical axis and configured to be disposed at a selected location; an optical signal source in optical communication with a surface of the crystal and configured to transmit an optical signal having an initial polarization to the surface, the surface configured to reflect at least a portion of the signal as a reflected signal; a detector configured to receive the reflected signal; and a processor configured to determine a polarization of the reflected signal and estimate the parameter at the location based on the polarization of the reflected signal.

A method of measuring a parameter includes: transmitting an optical signal having an initial polarization from an optical signal source to a surface of an optical crystal, the surface configured to reflect at least a portion of the signal as a reflected signal; returning the reflected signal to a detector; determining a polarization of the reflected signal; and estimating the parameter at a location of the crystal based on the polarization of the reflected signal.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a measurement system;

FIG. 2 illustrates an exemplary embodiment of an optical crystal of the measurement system of FIG. 1;

FIG. 3 illustrates an exemplary embodiment of a downhole system including the measurement system of FIG. 1; and

FIG. 4 illustrates one example of a method for estimating a parameter.

### DETAILED DESCRIPTION

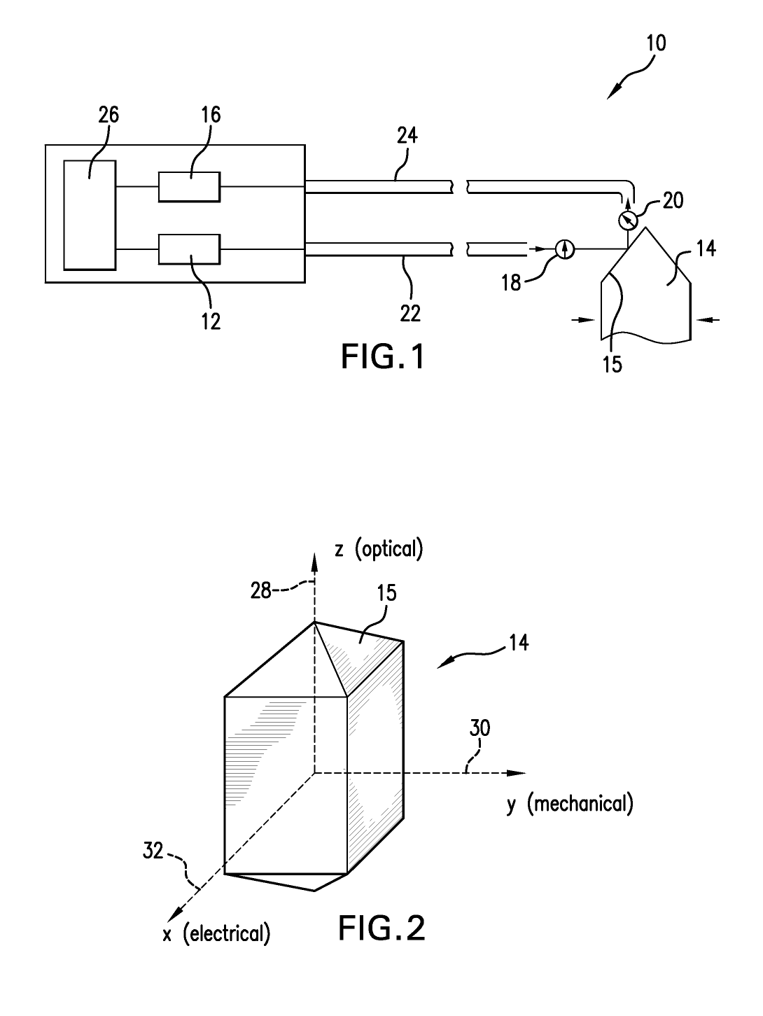

FIG. 1 illustrates an exemplary embodiment of a sensor assembly 10 that includes an optical signal source 12, a crystal 14 and an optical detector 16. The sensor assembly is configured to measure one or more parameters relating to a force, stress and/or temperature incident on the crystal 14. Examples of such parameters include temperature, pressure, vibration or shock, stress, strain, flow rate and density. The optical signal source 12 may be a light source such as a tunable light source, a LED and/or a laser, configured to emit an optical signal having a selected or known polarization.

The crystal 14 includes an anisotropic medium, such as a quartz crystal or fused quartz crystal. Other crystals may also be used, such as sapphire, ruby and zircon crystals. The crystal 14 is configured to be exposed to a force or pressure that elastically deforms the crystal 14. For example, the crystal 14 can be disposed in an environment for which temperature is to be measured, or be disposed in a fluid for which pressure is to be measured.

The sensor assembly 10 is configured so that an optical signal 18 is transmitted to be incident on a surface 15 of the crystal 14 and reflected from the surface 15 toward the detector 16 as a reflected signal 20. The detector 16 includes any device for detecting light, such as a photodetector or a photo-diode. The detector 16 measures characteristics of the reflected signal 20, such as frequency, intensity and polarization. In one embodiment, the detector 16 measures polarization of the reflected signal 20 via, for example, a polarimeter and/or a polarizer. The polarimeter may be based on an interferometer and/or an arrangement of polarizing filters and/or wave guides. In one embodiment, a Nichol prism is used to measure the polarization of the reflected signal.

Although the optical signal 18 is shown as being transmitted to and reflecting from an external surface of the crystal 14, the assembly is not so limited. In one embodiment, the reflecting surface may be facing toward the inside of the crystal. For example, the optical signal 18 may be transmitted to an interior of the crystal (e.g., along the optical axis) such that the optical signal light ray travels through the crystal, is internally reflected by a polished and/or angled surface of the crystal, and travels again through the crystal before the ray exits the crystal. The change in polarization of the reflected signal may be measured, e.g., the polarization of the reflected signal is measured and compared to an expected polarization

In one embodiment, the crystal 14 is a birefringent crystal. Birefringent materials decompose a beam of light that passes through the material into two beams of light, an ordinary ray and an extraordinary ray.

The sensor assembly 10 may also include features or components configured to transmit or direct the optical signal from the optical source to a location on a surface of the crystal. Any of various waveguide configurations may be used, such as one or more mirrors.

In one embodiment, as shown in FIG. 1, the sensor assembly 10 includes one or more optical fibers 22, 24 for propagating the optical signal 18 and/or the reflected signal 20. In this embodiment, the signal source 12 (e.g., a laser) is configured to launch the optical signal 18 having a selected wavelength and polarization into the optical fiber 22. The optical signal 18 reflects off of the surface 15 and is transmitted via the optical fiber 24 to the detector 16. The signal source 12 and/or the detector 16 may be in communication with one or more processors 26 which can be configured to perform various functions, such a controlling the signal source 12, receiving measurement signals or data from the detector 16 and measuring various parameters based on a change in polarization between the optical signal 18 and the return signal 20.

Referring to FIG. 2, in one embodiment, the crystal 14, such as a quartz crystal, has three axes that exhibit electrical, mechanical and optical properties. For example, the crystal 14 shown in FIG. 2 has an optical axis 28 shown as a Z-axis, a mechanical axis 30 shown as a Y-axis and an electrical axis 32 shown as an X-axis.

For a birefringent material, the optical axis 28 of the crystal 14 is the direction in which a ray of light transmitted through the crystal 14 does not experience birefringence or double refraction. Due to the internal structure of a birefringent crystal (the specific structure of the crystal lattice, the form of atoms or molecules of its components), light propagates along the optical axis differently than in other directions. Any rays travelling in a direction through the crystal that is parallel to the optical axis will not experience birefringence. The crystal 14 may be a uniaxial crystal that has only one optical axis, or may have multiple optical axes (e.g., biaxial).

The sensor assembly 10 utilizes changes in optical properties along the optical axis 28 in response to pressure and/or force on the mechanical axis 30. These changes are used to measure parameters of components and/or environments on or around the crystal 14, e.g., by measuring changes in polarization of light reflected from the crystal resulting from the pressure and/or force on the crystal 14. For example, parameters such as temperature, pressure and strain cause a corresponding force on the crystal 14, which results in a shift of polarization relative to the optical signal 18 (or a previously measured reflected signal 20).

The crystal 14 can be disposed at various components and/or environments to measure parameters associated therewith. For example, the crystal 14 can be disposed with a selected fluid to measure fluid pressure as well as fluid pressure changes. In another example, the crystal can be attached to a component so that a stress on, or deformation of, the component translates to a stress or force on the component. The crystal may be disposed in any environment in which a temperature is desired to be measured. Changes in temperature cause a deformation such as expansion or contraction of the crystal, which results in stress, changing optical properties of the crystal and causing a change in the polarization angle of light reflecting of a surface of the crystal. The crystal can be configured to directly contact the component or environment of interest, or be coupled to a device for transferring force (e.g., a piston or diaphragm coupled to a fluid, an expandable member configured to deform and cause a stress on the crystal due to changes in temperature).

In one embodiment, desired parts of the sensor assembly 10 can be isolated from the environment or component to be measured. For example, the crystal 14 may be disposed at the component or environment of interest, and components such as the detector 16, the signal source 12 and the processor 26 are remotely located and coupled to the crystal via the optical fibers 22 and 24.

In addition to optically measuring changes in polarization to measure various parameters, such parameters can be measured electrically. For example, force or pressure exerted on the mechanical axis 30 of the crystal 14 changes the electrical properties along the electrical axis 32, which can be detected using electronic circuits coupled to the crystal.

In one embodiment, the sensor assembly 10 is incorporated with other sensors, such as an electrical sensor coupled to a crystal or any other sensors configured to measure temperature, pressure or strain. Measurements from the sensor assembly 10 can be used along with other sensors to give additional resolution and accuracy to various measurements. The sensor assembly 10 could also be used to increase the fault tolerance of the sensor. The sensor assembly 10 could be used in conjunction with conventional electrical sensing to improve the accuracy of the measurements.

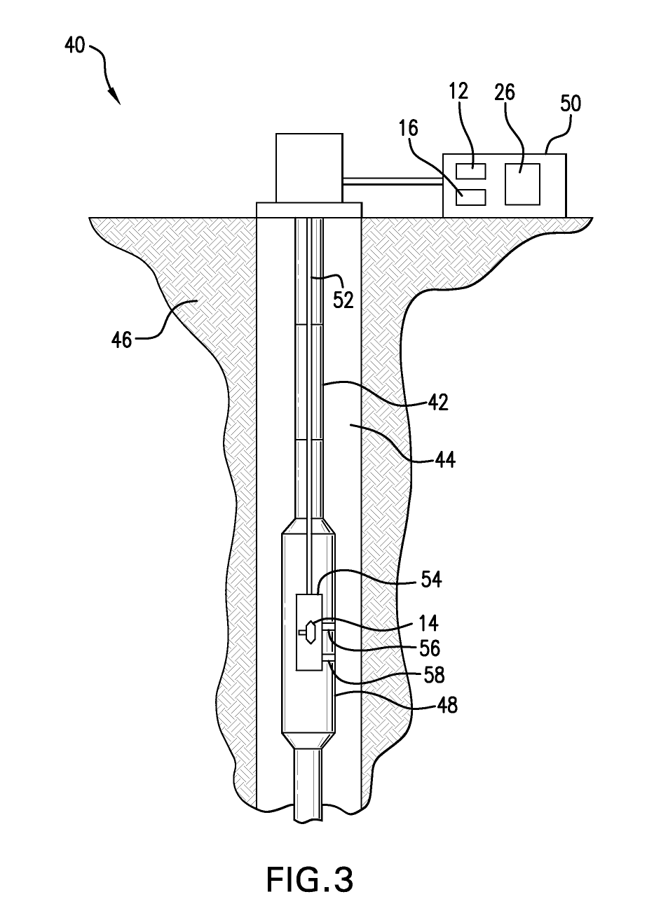

The sensor assembly 10 may be used in harsh environments, such as high temperature (e.g., greater than 500 degrees C.) and pressure environments. In one example, shown in FIG. 3, the sensor assembly 10 is disposed with an exemplary embodiment of a downhole drilling, monitoring, evaluation, exploration and/or production system 40. The system 40 includes a borehole string 42 disposed in a wellbore 44, which penetrates at least one earth formation 46 for performing functions such as extracting matter from the formation and/or making measurements of properties of the formation 46 and/or the wellbore 44 downhole. The borehole string 42 is made from, for example, a pipe, multiple pipe sections or flexible tubing. The system 40 and/or the borehole string 42 include any number of downhole tools 48 for various processes including drilling, hydrocarbon production, and measuring one or more physical quantities in or around a borehole. Various measurement tools 48 may be incorporated into the system 40 to affect measurement regimes such as permanent well monitoring, wireline measurement applications or logging-while-drilling (LWD) applications. For example, parts of the sensor assembly 10 having no active components could be deployed in wells with extreme temperatures and pressures for extended periods of time (e.g., up to 10 or more years).

In one embodiment, the sensor assembly 10 is included as part of the system 40 and is configured to measure or estimate various downhole parameters. The sensor assembly 10 includes a measurement unit 50 connected in operable communication with at least one optical fiber. The measurement unit 50 may be located, for example, at a surface location, a subsea location and/or a surface location on a marine well platform or a marine craft. The measurement unit 50 may also be disposed downhole as desired.

The measurement unit 50 includes, for example, one or more signal sources 12 and one or more signal detectors 16. Signal processing electronics may also be included in the measurement unit 20, for controlling the signal source 12 and the detector 16 and/or for processing reflected signals. In one embodiment, a processor 26 is in operable communication with the signal source 12 and the detector 16 and is configured to control the source 12, receive reflected signal data from the detector 16 and/or process reflected signal data (e.g., measure reflected signal polarization and/or estimate parameter(s) based on changes in polarization).

An optical conductor 52 is operably connected to the measurement unit 50 and is configured to be disposed downhole. The optical conductor 52, for example an optical fiber cable, includes one or more optical fibers for transmitting interrogation signals from the signal source 12 and/or returning reflected signals to the detector 16. In one embodiment, the optical conductor 52 includes the optical fibers 22 and 24 for transmitting optical signals 18 and return signals 20, respectively.

The optical conductor 52 is operably connected to at least one crystal 14 for measuring changes in reflected signal polarization. The crystal can be attached or coupled to a downhole component such as the tool 18 for measuring, e.g., strain and/or temperature of the tool 18. In one embodiment, the crystal 14 is disposed in a chamber 54 for exposure to temperature and/or pressure. For example, the chamber 54 is connected to a fluid inlet 56 configured to allow borehole fluid to enter the chamber 54, and may also be connected to a fluid outlet 58 to allow fluid to flow through the chamber 54. Various valves may be coupled to the inlet 56 and/or outlet 58 to control fluid flow into and out of the chamber 54. In this example, the temperature and/or pressure of the fluid causes the crystal 14 to deform, and accordingly causes the polarization of an optical signal to change when the optical signal 18 reflects off of a surface of the crystal.

As shown in FIG. 3, the sensor assembly 10 can be constructed so that only the crystal 14 and/or optical fiber(s) need be disposed in or near the environment or material to be measured. Because other components of the sensor assembly 10 are located away from the downhole environment, these components can be isolated from the harsh environments, increasing reliability of the sensor assembly and simplifying the design. In addition, isolating such components allows the sensor assembly 10 to be operated at extremely high temperatures, e.g., temperatures in excess of 500 degrees C.

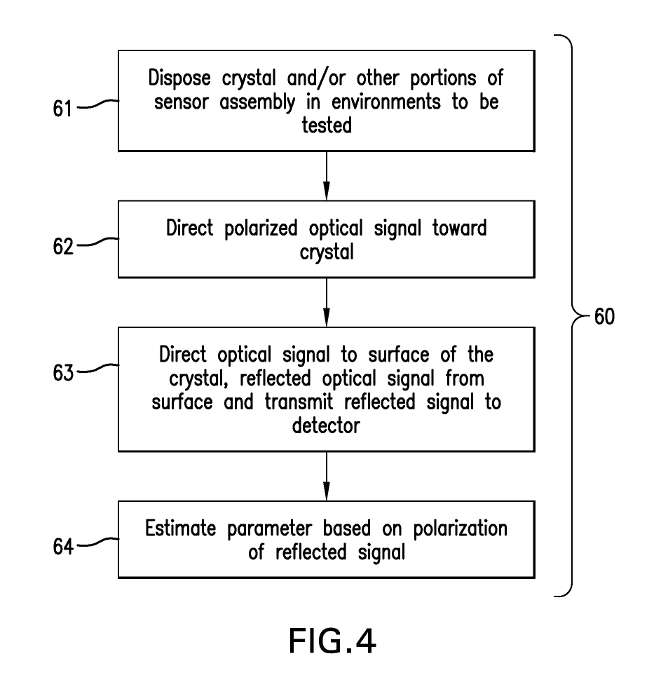

FIG. 4 illustrates a measurement method 60, which can be used to measure various parameters such as pressure, strain and temperature. The method 60 includes one or more stages 61-64. In one embodiment, the method 60 includes the execution of all of stages 61-64 in the order described. However, certain stages may be omitted, stages may be added, or the order of the stages changed.

In the first stage 61, a sensor assembly is disposed in an environment or disposed with a component or object to be tested. For example, the sensor assembly 10 is disposed so that the crystal 14 is disposed downhole and in optical communication with the measurement unit 50 via one or more optical fibers. Although this embodiment of the method 60 is discussed in conjunction with the downhole system 40, the method may be used with any environment or object to be measured.

The crystal 14 and other components of the sensor assembly 10, as well as other components such as the tool 48 may be embodied with any suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

In the second stage 62, an optical signal 18 having a selected or known polarization is launched from the optical signal source 12 to the crystal 14. In one embodiment, the signal 18 is linearly polarized, but is not so limited. For example, the signal 18 may be circularly or elliptically polarized. In one embodiment, the signal 18 is launched into an optical fiber or other waveguiding assembly (e.g., mirrors) in order to transmit the signal 18 to the surface of the crystal.

In the third stage 63, the optical signal 18 is directed to a surface 15 of the crystal 14. The optical signal 18 reflects off of the surface 15. In one embodiment, the surface 15 is a facet of the crystal that experiences substantial strain or deformation in response to a force exerted on the crystal 14. In one embodiment, the surface 15 is selected as the surface of the crystal 14 that experiences maximum change in strain or deformation and maximum change in optical properties due to the force. The optical signal 18 is, in one example, directed to a surface other than a surface that is parallel to the optical axis 28. The optical signal 18 may be directed to the surface along a direction that is at least substantially perpendicular to the optical axis 28. An optical waveguide such as the optical fiber 24 transmits a reflected signal 20 to the detector 16.

In the fourth stage 64, the reflected signal data is utilized to estimate various parameters on or around the crystal 14. For example, the detector 16 receives the reflected signal 20 and the detector 16 and/or processor 26 measures a polarization of the reflected signal 20. The change in polarization of the reflected signal 20 relative to the optical signal 18 is determined and correlated to a force on the crystal 14. For example, when polarized light is reflected off of a facet of the crystal that shows a change in optical properties due to deformation of the crystal 14, the polarization of the reflected light will be shifted proportional to the strain caused by forces from, e.g., pressure, temperature or mechanical force. This force can be used to measure parameters such as temperature, pressure, strain, vibration, strain and deformation of downhole components, acoustic events, and others.

The crystal 14 may be interrogated periodically or continuously so that changes in force on the crystal and corresponding measured parameters can be measured over time. The signals can be launched and measurements made in real time, e.g., during a downhole operation. Such measurements can be used to modify operation parameters such as downhole fluid (e.g., drilling mud) pressure.

The systems and methods described herein provide various advantages over prior art techniques. The systems and methods provide for a system having increased reliability and useful life. For example, detection components could be physically isolated from the crystal, e.g., only the crystal and an optical fiber need be disposed in the measurement environment. This allows the sensor to be operated in extreme conditions such as borehole environments having potential temperatures in excess of 500 degrees C. In addition, the systems described herein do not require the design and implementation of components such as an oscillator, resonating chamber, electrical connections to a crystal and/or electronic circuits to detect electrical properties changes, which results in reduced complexity and expense, as well as increased reliability relative to prior art sensors.

In support of the teachings herein, various analysis components may be used, including a digital and/or an analog system. Components of the sensor assembly, such as the signal source 12, the detector 16, the processor 26 and the measurement unit 50 and other components of the sensor assembly 10 and/or system 40, may have components such as a processor, storage media, memory, input, output, communications link, user interfaces, software programs, signal processors (digital or analog) and other such components (such as resistors, capacitors, inductors and others) to provide for operation and analyses of the apparatus and methods disclosed herein in any of several manners well appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

It will be recognized that the various components or technologies may provide certain necessary or beneficial functionality or features. Accordingly, these functions and features as may be needed in support of the appended claims and variations thereof are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for measuring a parameter, the apparatus comprising:
an optical crystal having an optical axis and configured to be disposed at a selected location;
an optical signal source in optical communication with a surface of the crystal and configured to transmit an optical signal having an initial polarization to the surface, the surface configured to reflect at least a portion of the signal as a reflected signal;
a detector configured to receive the reflected signal; and
a processor configured to determine a polarization of the reflected signal and estimate the parameter at the location based on the polarization of the reflected signal.

2. The apparatus of claim 1, wherein the optical crystal includes an optical axis and a mechanical axis, and the crystal is configured to be exposed to a force thereon, the force causing a deformation of the crystal.

3. The apparatus of claim 2, wherein the force is configured to be directed at least along the mechanical axis.

4. The apparatus of claim 2, wherein the surface is a facet of the crystal that experiences deformation in response to the force.

5. The apparatus of claim 1, wherein the optical signal is directed along a direction at least substantially perpendicular to the optical axis.

6. The apparatus of claim 1, further comprising a waveguiding assembly configured to transmit the optical signal to the crystal and transmit the reflected signal to the detector.

7. The apparatus of claim 6, wherein the optical signal source, the detector and the processor are remotely located relative to the crystal.

8. The apparatus of claim 6, wherein the waveguiding assembly includes one or more optical fibers.

9. The apparatus of claim 1, further comprising a waveguiding assembly configured to transmit the optical signal to the crystal and transmit the reflected signal to the detector, wherein the crystal is disposed at a downhole location within a borehole in an earth formation, and the optical signal source and the detector are disposed at one or more surface locations.

10. The apparatus of claim 1, wherein the parameter is at least one of temperature, strain, pressure, flow, density, vibration and deformation.

11. The apparatus of claim 1, wherein the processor is configured to estimate the parameter by calculating a change in polarization between the initial polarization and the reflected signal polarization.

12. A method of measuring a parameter, the method comprising:
transmitting an optical signal having an initial polarization from an optical signal source to a surface of an optical crystal, the surface configured to reflect at least a portion of the signal as a reflected signal;
returning the reflected signal to a detector;
determining a polarization of the reflected signal; and
estimating the parameter at a location of the crystal based on the polarization of the reflected signal.

13. The method of claim 12, wherein the optical crystal includes an optical axis and a mechanical axis, and the crystal is configured to be exposed to a force thereon, the force causing a deformation of the crystal.

14. The method of claim 13, wherein the surface is a facet of the crystal that experiences deformation in response to the force.

15. The method of claim 12, wherein estimating the parameter includes calculating a change in polarization between the initial polarization and the reflected signal polarization.

16. The method of claim 15, wherein estimating the parameter includes calculating a deformation of at least the surface of the crystal based on the change in polarization, estimating a force on the crystal based on the deformation, and correlating the force with a value of the parameter.

17. The method of claim 15, wherein the parameter is estimated based on a proportional relationship between the change in polarization and the parameter.

18. The method of claim 12, wherein transmitting the optical signal includes launching the optical signal into a first optical fiber in optical communication with the surface, and returning the reflected signal includes transmitting the reflected signal via a second optical fiber.

19. The apparatus of claim 1, wherein at least one of the optical signal and the reflected signal is transmitted via a waveguiding assembly.

20. The apparatus of claim 19, wherein the crystal is disposed at a downhole location within a borehole in an earth formation, and the optical signal source and the detector are disposed at one or more surface locations.
